(19) United States
(12) Patent Application Publication
(10) Pub. No.: US 2003/0145235 A1
(43) Pub. Date: Jul. 31, 2003

(54) Network adapter management

(76) Inventor: Tse Huong Choo, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/240,138

(22) PCT Filed: Jan. 29, 2002
(86) PCT No.: PCT/GB02/00416

(30) Foreign Application Priority Data
Jan. 31, 2001 (GB) 0102515.4

(51) Int. Cl. H04L 9/00

(52) U.S. Cl. 713/201

(57) ABSTRACT

An operating system comprising a kernel (100) incorporating mandatory access controls as a means to counter the effects posed by application compromise. The operating system uses a technique known as “containment” to at least limit the scope of damage when security breaches occur. In a preferred embodiment, each application supported by the operating system, is assigned a tag or label, each tag or label being indicative of a logically protected computing environment or “compartment”, and applications having the same tag or label belonging to the same compartment. By default, only applications running in the same compartment can communicate with each other. Access control rules define very narrow tightly-controlled communications paths between compartments.

### FIELD OF THE INVENTION

This invention relates to a trusted operating system and, in particular, to an operating system having enhanced protection against application compromise and the exploitation of compromised applications.

In recent years, an increasing number of services are being offered electronically over the Internet. Such services, particularly those which are successful and therefore lucrative, become targets for potential attackers, and it is known that a large number of Internet security breaches occur as a result of compromise of the applications forming the electronic services.

### BACKGROUND TO THE INVENTION

The applications that form electronic services are in general sophisticated and contain many lines of code which will often have one or more bugs in it, thereby making the application more vulnerable to attack. When an electronic service is offered on the Internet, it is exposed to a large population of potential attackers capable of probing the service for vulnerabilities and, as a result of such bugs, there have been known to be security violations.

Once an application has been compromised (for example, by a buffer overflow attack), it can be exploited in several different ways by an attacker to breach the security of the system.

Increasingly, single machines are being used to host multiple services concurrently (e.g. ISP, ASP, xSP service provision), and it is therefore becoming increasingly important that not only is the security of the host platform protected from application compromise attacks, but also that the applications are adequately protected from each other in the event of an attack.

One of the most effective ways of protecting against application compromise at the operating system level is by means of kernel enforced controls, because the controls implemented in the kernel cannot be overridden or subverted from user space by any application or user. In known systems, the controls apply to all applications irrespective of the individual application code quality.

There are two basic requirements at the system level in order to adequately protect against application compromise and its effects. Firstly, the application should be protected against attack to the greatest extent possible, exposed interfaces to the application should be as narrow as possible and access to such interfaces should be well controlled. Secondly, the amount of damage which a compromised application can do to the system should be limited to the greatest possible extent.

In a known system, the above two requirements are achieved by the abstract property of “containment”. An application is contained if it has strict controls placed on which resources it can access and what type of access it has, even when the application has been compromised.

Containment also protects an application from external attack and interference. Thus, the containment property has the potential to at least mitigate many of the potential exploitative actions of an attacker.

The most common attacks following the compromise of an application can be roughly categorized as one of four types, as follows (although the consequences of a particular attack may be a combination of any or all of these):

1. Misuse of privilege to gain direct access to protected system resources. If an application is running with special privileges (e.g. an application running as root on a standard Unix operating system), then an attacker can attempt to use that privilege in unintended ways. For example, the attacker could use that privilege to gain access to protected operating resources or interfere with other applications running on the same machine.

2. Subversion of application enforced access controls. This type of attack gains access to legitimate resources (i.e. resources that are intended to be exposed by the application) but in an unauthorized manner. For example, a web server which enforces access control on its content before it serves it, is one application susceptible to this type of attack. Since the web server has uncontrolled direct access to the content, then so does an attacker who gains control of the web server.

3. Supply of false security decision making information. This type of attack is usually an indirect attack in which the compromised application is usually a support service (such as an authorization service) as opposed to the main service. The compromised security service can then be used to supply false or forged information, thereby enabling an attacker to gain access to the main service. Thus, this is another way in which an attacker can gain unauthorized access to resources legitimately exposed by the application.

Illegitimate use of unprotected system resources. An attacker gains access to local resources of the machine which are not protected but nevertheless would not normally be exposed by the application. Typically, such local resources would then be used to launch further attacks. For example, an attacker may gain shell access to the hosting system and, from there, staged attacks could then be launched on other applications on the machine or across the network.

With containment, misuse of privilege to gain direct access to protected system resources has much less serious consequences than without containment, because even if an attacker makes use of an application privilege, the resources that can be accessed are bounded by what has been made available in the application's container. Similarly, in the case of unprotected resources, using containment, access to the network from an application can be blocked or at least very tightly controlled. With regard to the supply of false security decision making information, containment mitigates the potential damage caused by ensuring that the only access to support services is from legitimate clients, i.e. the application services, thereby limiting the exposure of applications to attack.

Mitigation or prevention of the second type of attack, i.e. subversion of application enforced access controls, is usually achieved at the application design, or at least configuration level. However, using containment, it can be arranged that access to protected resources from a large untrusted application (such as a web server) must go through a smaller, more trustworthy application.

Thus, the use of containment in an operating system effectively increases the security of the applications and limits any damage which may be caused by an attacker in the event that an application is compromised. Referring to FIG. 1 of the drawings, there is illustrated an exemplary architecture for multi-service hosting on an operating system with the containment property. Containment is used in the illustrated example to ensure that applications are kept separated from each other and critical system resources. An application cannot interfere with the processing of another application or obtain access to its (possibly sensitive) data. Containment is used to ensure that only the interfaces (input and output) that a particular application needs to function are exposed by the operating system, thereby limiting the scope for attack on a particular application and also the amount of damage that can be done should the application be compromised. Thus, containment helps to preserve the overall integrity of the hosting platform.

Kernel enforced containment mechanisms in operating systems have been available for several years, typically in operating systems designed for handling and processing classified (military) information. Such operating systems are often called ‘Trusted Operating Systems’.

The containment property is usually achieved through a combination of Mandatory Access controls (MAC), and Privileges. MAC protection schemes enforce a particular policy of access control to the system resources such as files, processes and network connections. This policy is enforced by the kernel and cannot be overridden by a user or compromised application.

Despite offering the attractive property of containment, trusted operating systems have not been widely used outside of the classified information processing systems for two main reasons. Firstly, previous attempts at adding trusted operating system features to conventional operating systems have usually resulted in the underlying operating system personalities being lost, in the sense that they no longer support standard applications or management tools, and they can no longer be used or managed in standard ways. As such, they are much more complicated than their standard counterparts. Secondly, previous trusted operating systems have typically operated a form of containment which is more akin to isolation, i.e. too strong, and as such has been found to be limited in scope in terms of its ability to usefully and effectively secure [existing] applications without substantial and often expensive integration efforts.

Our first co-pending International Application defines an arrangement which seeks to overcome the problems outlined above and which provides a trusted operating system having a containment property which can be usefully used to effectively secure a large number of existing applications without application modification.

The first aspect of the invention of our first co-pending International Application provides an operating system for supporting a plurality of applications, wherein at least some of said applications are provided with a label or tag, each label or tag being indicative of a logically protected computing environment or “compartment”, each application having the same label or tag belonging to the same compartment, the operating system further comprising means for defining one or more communication paths between said compartments, and means for preventing communication between compartments where a communication path there between is not defined.

The second aspect of the invention of our first co-pending International Application provides an operating system for supporting a plurality of applications, the operating system further comprising a plurality of access control rules, which may beneficially be added from user space and enforced by means provided in the kernel of the operating system, the access control rules defining the only communication interfaces between selected applications (whether local to or remote from said operating system).

This, in the first and second aspects of the invention of our first co-pending International Application, the property of containment is provided by mandatory protection of processes, files and network resources, with the principal concept being based on the compartment, which is a semi-isolated portion of the system. Services and applications on the system are run within separate compartments. Beneficially, within each compartment is a restricted subset of the host file system, and communication interfaces into and out of each compartment are well-defined, narrow and tightly controlled. Applications within each compartment only have direct access to the resources in that compartment, namely the restricted file system and other applications within that compartment. Access to other resources, whether local or remote, is provided only via the well-controlled communication interfaces.

Simple mandatory access controls and application or process labeling are beneficially used to realize the concept of a compartment. In a preferred embodiment, each process (or thread) is given a label, and processes having the same labels belong to the same compartment. The system preferably further comprises means for performing mandatory security checks to ensure that processes from one compartment cannot interfere with processes from another compartment. The access controls can be made very simple, because labels either match or they do not.

In a preferred embodiment of the present invention, filesystem protection is also mandatory. Unlike traditional trusted operating systems, the preferred embodiment of the first aspect of the invention of our first co-pending International Application does not use labels to directly control access to the filesystem. Instead, the file systems of the first and second aspects of the invention of our first co-pending International Application are preferably, at least partly, divided into sections, each section being a non-overlapping restricted subset (i.e. a chroot) of the main filesystem and associated with a respective compartment. Applications running in each compartment only have access to the associated section of the filesystem. The operating system of the first and/or second aspects of the invention of our first co-pending International Application is preferably provided with means for preventing a process from transitioning to root from within its compartment as described below with reference to the fourth aspect of the invention of our first co-pending International Application, such that the chroot cannot be escaped. The system may also include means for making selected files within a chroot immutable.

The flexible but controlled communication paths between compartments and network resources are provided through narrow, tightly-controlled communication interfaces which are preferably governed by one or more rules which may be defined and added from user space by a security administrator or the like, preferably on a per-compartment basis. Such communication rules eliminate the need for trusted proxies to allow communication between compartments and/or network resources.

The containment properties provided by the first and/or second aspects of the invention of our first co-pending International Application may be achieved by kernel level enforcement means, user-level enforcement means, or a combination of the two. In a preferred embodiment of the first and/or second aspects of the invention of our first co-pending International Application, the rules used to specify the allowed access between one compartment and other compartments or hosts, are enforced by means in the kernel of the operating system, thereby eliminating the need for user space interposition (such as is needed for existing proxy solutions). Kernel enforced compartment access control rules allow controlled and flexible communication paths between compartments in the compartmentalized operating system of the first aspect of the invention of our first co-pending International Application without requiring application modification.

The rules are beneficially in the form:

source->destination method m[attr] [netdev n]

where:

source/destination is one of:

COMPARTMENT (a named compartment)

HOST (possibly a fixed Ipv4 address)

NETWORK (possibly an Ipv4 subnet)

| | |
|---|---|
| m: | supported kernel mechanism, e.g. tcp (transmission control |
| | protocol), udp (user-datagram protocol), msg (message queues), |
| | shm (shared-memory), etc. |
| attr: | attributes further qualifying the method m |
| n: | a named network interface if applicable, e.g. eth() |

Wildcards can also be used in specifying a rule. The following example rule allows all hosts to access the web server compartment using TCP on port 80 only:

HOST*->COMPARTMENT web METHOD tcp PORT 80

The following example rule is very similar, but restricts access to the web server compartment to hosts that have a route to the eth0 network interface on an exemplary embodiment of the system:

HOST*->COMPARTMENT web METHOD tcp PORT 80 NETDEV eth0

Means are preferably provided for adding, deleting and/or listing the access control rules defined for the operating system, beneficially by an authorized system administrator. Means may also be provided for adding reverse TCP rules to enable two-way communication to take place between selected compartments and/or resources.

The rules are beneficially stored in a kernel-level database, and preferably added from user space. The kernel-level database is beneficially made up of two hash tables, one of the tables being keyed on the rule source address details and the other being keyed on the rule destination address details. Before a system call/ISR (Interrupt Service Routine) is permitted to proceed, the system is arranged to check the database to determine whether or not the rules define the appropriate communication path. The preferred structure of the kernel-level database enables efficient lookup of kernel enforced compartment access control rules because when the security check takes place, the system knows whether the required rule should match the source address details or the destination address details, and can therefore select the appropriate hash table, allowing a O(1) rate of rule lookup. If the necessary rule defining the required communication path is not found, the system call will fail.

The third aspect of the invention of our first co-pending International Application provides an operating system for supporting a plurality of applications, said operating system comprising a database in which is stored a plurality of rules defining permitted communication paths (i.e. source and destination) between said applications, said rules being stored in the form of at least two encoded tables, the first table being keyed on the rule source details and the second table being keyed on the rule destination details, the system further comprising means, in response to a system call, for checking at least one of said tables for the presence of a rule defining the required communication path and for permitting said system call to proceed only in the event that said required communication path is defined.

Said encoded tables preferably include at least one hash table.

Often, on gateway-type systems (i.e. hosts with dual-interfaces connected to both internal and external networks), it is desirable to a) constrain the running server-processes to use only a subset of the available network interfaces, b)explicitly specify which remote-hosts are accessible and which are not, and c) have such restrictions apply on a per-process/service basis on the same gateway system.

A gateway system may be physically attached to several internal sub-networks, so it is essential that a system-administrator classifies which server-processes may be allowed to access which network-interface so that if a server-process is compromised from a remote source, it cannot be used to launch subsequent attacks on potentially vulnerable back-end hosts via another network-interface.

Traditionally, fire walls have been used to restrict access between hosts on a per-IP-address and/or IP-port level. However, such fire walls are not fine-grained enough of gateway systems hosting multiple services, primarily because they cannot distinguish between different server processes. In addition, in order to specify different sets of restrictions, separate gateway systems with separate sets of firewall rules are required.

We have devised an arrangement which seeks to overcome the problems outlined above. Thus, our second co-pending International Application provides a gateway system having a dual interface connected to both internal and external networks for hosting a plurality of services running processes and/or threads, the system comprising means for providing at least some of said running processes and/or threads with a tag or label indicative of a compartment, processes/threads having the same tag or label belonging to the same compartment, the system further comprising means for defining specific communication paths and/or permitted interface connections between said compartments and local and/or remote hosts or networks, and means for permitting communication between a compartment and a host or network only in the event that a communication path or interface connection there between is defined.

Thus, in the invention of our second co-pending International Application, access control checks are placed, preferably in the kernel/operating system of the gateway system. Such access control checks preferably consult a rule-table which specifies which classes of processes are allowed to access which subnets/hosts. Restrictions can be specified on a per-service (or per-process/thread) level. This means that the view of the back-end network is variable on a single gateway host. Thus, for example, if the gateway were to host two types of services each requiring access to two different back-end hosts, a firewall according to the prior art would have to specify that the gateway host could access both of these back-end hosts, whereas with the present invention, it is possible to specify permitted communication paths at a finer level, i.e. which services are permitted to access which hosts. This increases security somewhat because it greatly reduces the risk of a service accessing a host which it was not originally intended to access.

In a preferred embodiment of the invention of our second co-pending International Application, the access-control checks are implemented in the kernel/operating system of the gateway system, such that they cannot be bypassed by user-space processes.

Thus in a first exemplary embodiment of the invention of our second co-pending International Application, the kernel of the gateway system is provided with means for attaching a tag or label to each running process/thread, the tags/labels indicating notionally which compartment a process belongs to. Such tags may be inherited from a parent process which forks a child. Thus, a service comprising a group of forked children cooperating to share the workload, such as a group of slave Web-server processes, would possess the same tags and be placed in the same ‘compartment’. The system administrator may specify rules, for example in the form:

Compartment X->Host Y [using Network Interface Z] or

Compartment X->Subnet Y [using Network Interface Z]

which allow processes in a named compartment X to access either a host or a subnet Y, optionally restricted by using only the network-interface named Z. In a preferred embodiment, such rules are stored in a secure configuration file on the gateway system and loaded into the kernel/operating system at system startup so that the services which are then started can operate. When services are started, their start-up sequence would specify which compartment they would initially be placed in. In this embodiment, the rules are consulted each time a packet is to be sent from or delivered to Compartment X by placing extra security checks, preferably in the kernel's protocol stack.

In a second exemplary embodiment of the invention of our second co-pending International Application, a separate routing-table per-compartment is provided. As in the first embodiment described above, each process possesses a tag or label inherited from its parent. Certain named processes start with a designated tag configured by a system administrator. Instead of specifying rules, as described above with reference to the first exemplary embodiment, a set of configuration files is provided (one for each compartment) which the configure the respective compartment's routing-table by inserting the desired routine-table entries. Because the gateway system could contain an un-named number of compartments, each compartment's routing-table is preferably empty by default (i.e. no entries).

The use of routing-tables instead of explicit rules can be achieved because the lack of a matching route is taken to mean that the remote host which is being attempted to be reached is reported to be unreachable. Routes which do match signify acceptance of the attempt to access that remote host. As with the rules in the first exemplary embodiment described above, routing-entries can be specified on a per-host (IP-address) or a per-subnet basis. All that is required is to specify such routing-entries on a per-compartment basis in order to achieve the same functionality as in the first exemplary embodiment.

As explained above, attacks against running server-processes/daemons (e.g. buffer-overflow, stack-smashing) can lead to a situation where a remote attacker illegally acquires root/administrator-equivalent access on the system hosting the server processes. Having gained administrator access on such a system, the attacker is then free to launch other security breaches, such as reading sensitive configuration/password files, private databases, private keys, etc. which may be present on the compromised system.

Such attacks may be possible if:

a) the server-process runs as administrator and is broken into at run-time due to a software-bug internally;

b) the server-process is initially started as administrator, but was programmed to drop administrator privileges for the duration of most of its operation with the selective ability to regain administrator privileges prior to performing some privileged operation. In such cases, the server-process retains the ability to transition back to root (for some specific purpose) but an attacker, once they have gained control of the process, can do so outside of the original intended purpose;

c) the server-process is initially started as an unprivileged user, but acquires administrator access by subverting the original server-process first and then using that as a means to subvert an external setuid-root program which may be vulnerable in the ways described above.

In accordance with the prior art, one immediate solution to these problems is to plug/fix the specific buffer-overflow bug that initially allowed the attack to occur. The obvious disadvantage to this is, of course, that it is purely reactionary and does not preclude further buffer-overflow bugs from being discovered and exploited in future. Another solution proposed by the prior art, is to arrange for existing functionality in an operating system, e.g. UNIX, to drop all root-equivalent access with the intention of never transitioning back to it. Whilst this prevents the running process from dropping back to root unexpectedly, it does not prevent the program from operating an external setuid-root program that has been, for example, carelessly left lying around and which is vulnerable to being broken if fed some invalid input. If this were to occur, the compromised process running as an unprivileged user could execute the setuid-root program feeding it input that would then cause it to come under the control of the attacker.

We have devised an arrangement which seeks to overcome the problems outlined above. Thus, the fourth aspect of the invention of our first co-pending International Application provides an operating system for supporting a plurality of applications, the operating system comprising means for providing at least some of said applications with a tag or label, said tags or labels being indicative of whether or not an application is permitted to transition to root in response to a request, means for identifying such a request, determining from its tag or label whether or not an application is permitted to transition to root and permitting or denying said transition accordingly.

In a preferred embodiment, at least one of said tags or labels indicates that an application to which it as attached or with which it is associated is “sealed” therefore immutable.

Thus, the fourth aspect of the invention of our first co-pending International Application introduces a way to stop selected server processes from making the transition to the administrator-equivalent state by marking the processes “sealed” against such state transitions. Whenever those processes attempt to make such a transition, either by invoking a system-routine specifically for such purposes, or by executing an external program marked as ‘setuid-root’ (i.e. programs which have been previously tagged by the system administrator as having the ability to execute as the administrator regardless of who invoked it), or by any other means, then the operating system will disallow the system-call or the attempt to execute such a marked program.

Advantages provided by the operating system according to the fourth aspect of the invention of our first co-pending International Application include the fact that restriction against root-equivalent access is unconditional and remains in force regardless of how many undiscovered software bugs remain to be exploited in the server-process to be run. If a new exploitable bug is discovered, the restriction remains in place as it did previously with other bugs, regardless of the nature of the new bug. Obviously, this would not be possible in the case where bugs are required to be fixed as they are discovered. Further, the arrangement of fourth aspect of the invention of our first co-pending International Application fixes the external setuid-root problem where an attacker attempts to subvert an external program that has the capability to run as root instead of the original process. In the arrangement of the fourth aspect of the invention of our first co-pending International Application, any such attempts are tracked in the operating system and the arrangement can be configured to deny the attempt by a marked process from executing such a setuid-root program. In addition, no changes to the original source code of the protected process are required, arbitrary binaries can be run with the assurance that they will not drop back to root.

Trusted Operating Systems typically perform labeling of individual network adapters in order to help determine the required sensitivity label to be assigned to an incoming network packet. Sometimes, other software systems, such as fire walls, perform interface labeling (or colouring as it is sometimes called) to determine which interfaces are to be marked potentially “hostile” or non-hostile. This corresponds to the view of a corporate network as being trusted/secure internally and untrusted/insecure for external Internet links (see FIG. 15 of the drawings).

For network adapters (NICs) that remain static during the operation of a computer system, the labeling can be performed during system startup. However, there are classes of NIC which can be dynamically activated on a system, such as “soft” adapters for handling PPP links or any other network-device abstraction (e.g. VLANs, VPNs). Examples of such dynamic adapters include:

PPP links, e.g. modem connection to an ISP. Typically, a soft adapter is created representing the PPP connection to the ISP.

Virtual LANs (VLANs)—servers can host software-services operating in a private virtual network using VLANs. Such VLANs can be set up dynamically (on demand, say) so the server hosting such services has to be able to correctly label these interfaces if using a

Trusted Operating System or a derivative.

The largely static nature of the configuration shown in FIG. 15 of the drawings means that there is little need to handle a new adapter. If a system-administrator wishes to add a new adapter to the dual-homed host 700, he/she would typically bring down the system, physically add the adapter and configure the system to recognize the new adapter properly. However, this process is not suitable in the case where the system which requires interface labeling has the kind of dynamic interfaces mentioned above.

If no label is applied to the adapter, incoming packets on the adapter would not be assigned correct labels which might violate the security of the system in question. Further, outgoing packets (which presumably have a label correctly assigned to them) cannot be matched correctly against the adapter on which the packet is to be transmitted, therefore violating the security of the system in question.

### SUMMARY OF THE INVENTION

We have devised an arrangement which seeks to overcome the problems outlined above. Thus, in accordance with this invention, there is provided an operating system comprising means for dynamically assigning a label to a newly-installed adapter substantially upon activation thereof, the label depending upon the attributes of said adapter, and means for removing said label when said adapter is de-activated.

Thus, when a newly-installed adapter in the operating system is first activated, a label is reliably assigned thereto prior to reception of incoming packets, thereby ensuring that no unlabeled packets are created and passed on to the network protocol stack. Because dynamic adapters are catered for in the operating system of the present invention, new areas of functionality for such labeled systems are opened up, e.g. as a router, mobile device. Further, the label assigned to the adapter can be a function of the run-time properties of the newly-activated adapter. For example, it may be desirable to distinguish between different PPP connections to various ISP's. This cannot be done by assigning a label to the adapter-name (e.g. adapter “ppp0” is to be assigned label L0) because the adapter names are created dynamically and the actual properties of the adapter may vary. By choosing a label appropriate to the adapter, it can be ensured that any security checks based on the label function properly. This is especially important with respect to Trusted Operating Systems (in particular, as defined with reference to the first and second aspects of the invention of our first co-pending International Application) which also apply labels to other system objects, such as processes, network connections, files, pipes, etc., in the sense that the label applied to the adapter has to be correct with respect to the other labels already present on the system.

The kernel/operating system typically has software-routines which are invoked when a new adapter is activated. In on exemplary embodiment of the present invention, such routines are modified to also assign a label depending on the attributes of the newly-formed adapter, e.g. by consulting a ruleset or configuration table. Similarly, there are routines which are invoked when adapters are de-activated, which are modified to remove the label previously assigned.

Referring back to the first and second aspects of the invention of our first co-pending International Application, there is defined an operating system which augments each process and network interface with a tag indicating the compartment to which it belongs. In an exemplary embodiment, means provided in the kernel consult a rulebase whenever a process wishes to communicate with another process (in the Linux operating system, by using any of the standard UNIX inter-process communication mechanisms). The communication succeeds only if there is a matching rule in the rulebase. In the preferred embodiment, the rulebase resides in the kernel, but as explained above, to be more practical, it is preferably able to be initialized and dynamically maintained and queried by an administrative program, preferably in user-space.

Thus, the fifth aspect of the invention of our first co-pending International Application provides an operating system comprising a kernel including means for storing a rulebase consisting of one or more rules defining permitted communication paths between system objects, and user-operable means for adding, deleting and/or listing such rules.

Thus, in the operating system of the fifth aspect of the invention of our first co-pending International Application, it is possible to perform not just access control over TCP and UDP packets, but also other forms of inter-process communication that exist on the operating system (in a Linux system, these would include Raw IP packets, SysV messages, SysV shared memory and SysV semaphores).

In an exemplary embodiment of the fifth aspect of the invention of our first co-pending International Application, the user space program needs to be able to send and receive data from the kernel in order to change and list the entries in its rulebase. In a preferred embodiment, this is implemented by the inclusion in the operating system of a kernel device driver which provides two entry points. The first entry point is for the ‘ioctl’ system call (ioctl is traditionally used to send small amounts of data or commands to a device. The first entry point is arranged to be used for three operations. Firstly, it can be used to specify a complete rule and add it to a rulebase. Secondly, the same data can be used to delete that rule. Thirdly, as an optimization, a rule can be deleted by its ‘reference’, which in one exemplary embodiment of the invention, is a 64-bit tag which is maintained by the kernel.

The second entry point is for a “/proc” entry. When the user space program opens this entry, it can read a list of rules generated by the kernel. The reason for this second entry point is that it is a more efficient mechanism by which to read the list of rules than via an ioctl command, and can be more easily read by other user processes which do not have to be specially written to recognize and handle the specific ‘ioctl’ commands for the kernel module.

### BRIEF DESCRIPTION OF THE DRAWINGS

FIG. 1 is a schematic illustration of an exemplary architecture for multi-service hosting on an operating system with the containment property;

FIG. 2 is a schematic illustration of an architecture of a trusted Linux host operating system according to an exemplary embodiment of the present invention;

FIG. 3 illustrates an exemplary modified data type used in the operating system illustrated in FIG. 2;

FIG. 4 illustrates the major networking data types in Linux IP-networking;

FIG. 5 illustrates the propagation of struct csecinfo data-members for IP-networking;

FIG. 6 illustrates schematically three exemplary approaches to building containment into a Linux kernel;

FIG. 7 illustrates schematically the effect of the rule;

HOST*->COMPARTMENT x METHOD TCP PORT 80;

FIG. 8 illustrates schematically the spectrum of options available for the construction of a hybrid containment prototype operating system;

FIG. 9 illustrates schematically the desirability of updating replicated kernel state in synchrony;

FIG. 10 illustrates schematically an exemplary configuration of Apache and two Tomcat Java Vms;

FIG. 11 illustrates schematically the layered chroot-ed environments in the Trusted Linux illustrated in FIG. 2;

FIG. 12 illustrates schematically the process of efficient lookup of kernel enforced compartment access control rules;

FIG. 13 illustrates schematically an exemplary embodiment of a trusted gateway system according to an aspect of the present invention;

FIG. 14 illustrates schematically the operation of an operating system according to an exemplary embodiment of an aspect of the present invention; and

FIG. 15 illustrates schematically an exemplary embodiment of an operating system according to the prior art.

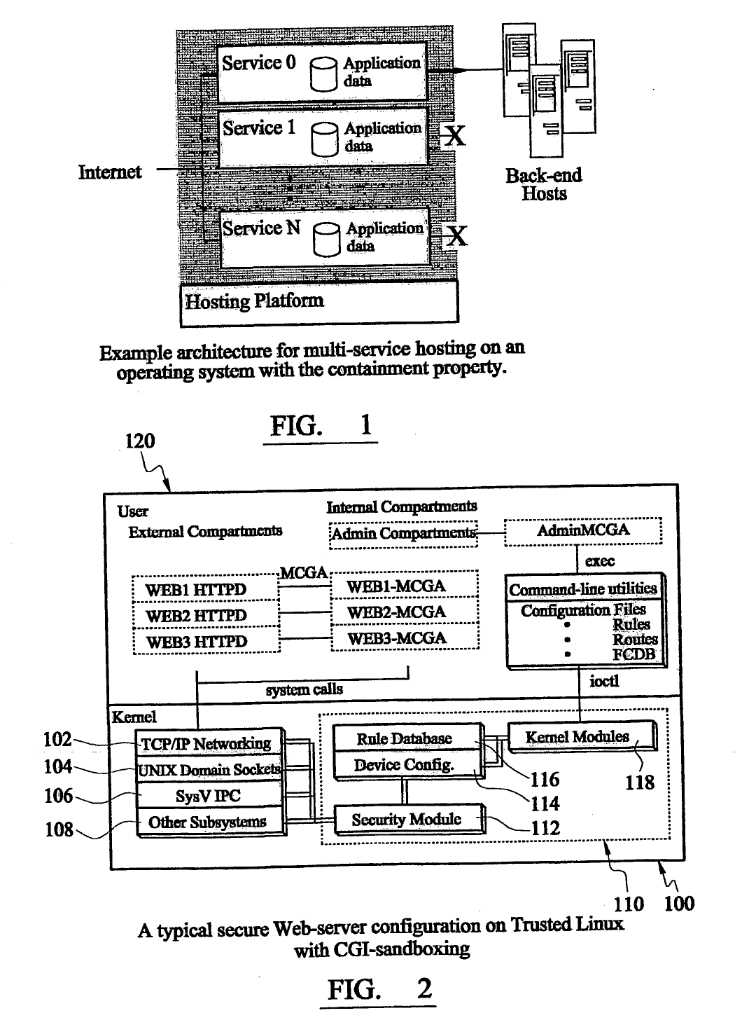

### DETAILED DESCRIPTION OF THE INVENTION

In summary, similar to the traditional trusted operating system approach, the property of containment is achieved in the operating system in an exemplary embodiment of the present invention by means of kernel level mandatory protection of processes, files and network resources. However, the mandatory controls used in the operating system of the present invention are somewhat different to those found on traditional trusted operating systems and, as such, they are intended to at least reduce some of the application integration and management problems associated with traditional trusted operating systems.

The key concept of a trusted operating system according to the invention is the ‘compartment’, and various services and applications on a system are run within separate compartments. Relatively simple mandatory access controls and process labeling are used to create the concept of a compartment. In the following exemplary embodiment of a trusted operating system according to the invention, each process within the system is allocated a label, and processes having the same label belong to the same compartment. Kernel level mandatory checks are enforced to ensure that processes from one compartment cannot interfere with processes from another compartment. The mandatory access controls are relatively simple in the sense that labels either match or they do not. Further, there is no hierarchical ordering of labels within the system, as there is in some known trusted operating systems.

Unlike traditional trusted operating systems, in the present invention, labels are not used to directly control access to the main filesystem. Instead, filesystem protection is achieved by associating a different section of the main filesystem with each compartment. Each such section of the file system is a chroot of the main filesystem, and processes running within any compartment only have access to the section of filesystem which is associated with that compartment. Importantly, via kernel controls, the ability of a process to transition to root from within a compartment is removed so that the chroot cannot be escaped. An exemplary embodiment of the present invention also provides the ability to make at least selected files within a chroot immutable.

Flexible communication paths between compartments and network resources are provided via narrow, kernel level controlled interfaces to TCP/UDP plus most IPC mechanisms. Access to these communication interfaces is governed by rules specified by the security administrator on a ‘per compartment’ basis. Thus, unlike in traditional trusted operating systems, it is not necessary to override the mandatory access controls with privilege or resort to the use of user level trusted proxies to allow communication between compartments and network resources.

The present invention thus provides a trusted operating systems which offers containment, but also has enough flexibility to make application integration relatively straightforward, thereby reducing the management overhead and the inconvenience of deploying and running a trusted operating system.

The architecture and implementation of a specific exemplary embodiment of the present invention will now be described. In the following description, numerous specific details are set forth in order to provide a thorough understanding of the present invention. It will be apparent, however, to one skilled in the art, that the invention may be practiced without limitation to these specific details. In other instances, well known methods and structures have not been described in detail so as to avoid unnecessarily obscuring the present invention.

In the following description, a trusted Linux operating system is described in detail, which system is realized by modification to the base Linux kernel to support containment of user-level services, such as HTTP-servers. However, it will be apparent to a person skilled in the art that the principles of the present invention could be applied to other types of operating system to achieve the same or similar effects.

The modifications made to a Linux operating system to realize a trusted operating system according to an exemplary embodiment of the invention, can be broadly categorized as follows:

1. Kernel modifications in the areas of:

TCP/IP networking

Routing-tables and routing-caches

System V IPC—Message queues, shared memory and semaphores

Processes and Threads

UID handling

2. Kernel configuration interfaces in the form of:

Dynamically loadable kernel modules

Command-line utilities to communicate with those modules

3. User-level scripts to administer/configure individual compartments:

Scripts to start/stop compartments

Referring to FIG. 2 of the drawings, there is illustrated an architecture of a trusted Linux host operating system according to an exemplary embodiment of the invention, including the major areas of change to the base Linux kernel and the addition of a series of compartments in user-space implementing Web-servers capable of executing CGI-binaries in configurable chroot jails.

Thus, with reference to FIG. 2, a base Linux kernel 100 generally comprises TCP/IP Networking means 102, UNIX domain sockets 104, Sys V IPC means 106 and other subsystems 108. The trusted Linux operating system additionally comprises kernel extensions 110 in the form of a security module 112, a device configuration module 114, a rule database 116 and kernel modules 118. As shown, at least some of the Linux kernel subsystems 102, 104, 106, 108 have been modified to make call outs to the kernel level security module 112. The security module 112 makes access control decisions and is responsible for enforcing the concept of a compartment, thereby providing containment.

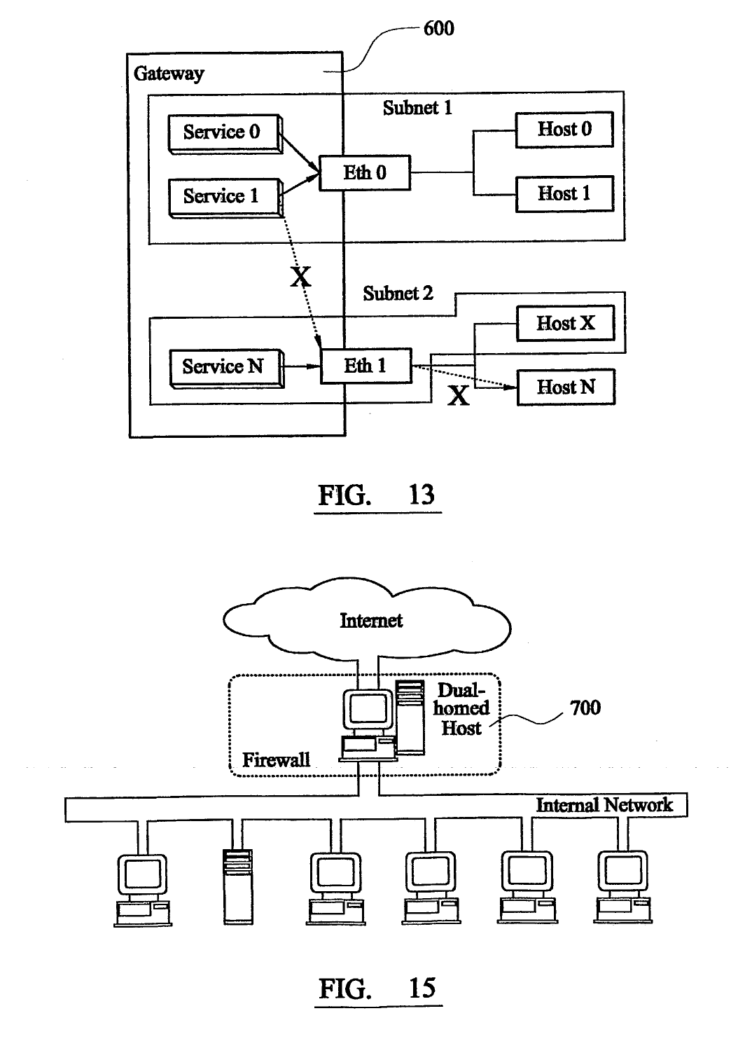

The security module 112 additionally consults the rule database 116 when making a decision. The rule database 116 contains information about allowable communication paths between compartments, thereby providing narrow, well-controlled interfaces into and out of a. compartment (see also FIG. 12 of the drawings).

FIG. 2 of the drawings also illustrates how the kernel extensions 110 are administered from user space 120 via a series of ioctl commands. Such ioctl commands take two forms: some to manipulate the rule table and others to run processes in particular compartments and configure network interfaces.

User space services, such as the web servers shown in FIG. 2, are run unmodified on the platform, but have a compartment label associated with them via the command line interface to the security extensions. The security module 112 is then responsible for applying the mandatory access controls to the user space services based on their applied compartment label. It will be appreciated, therefore, that the user space services can thus be contained without having to modify those services.

The three major components of the system architecture described with reference to FIG. 2 of the drawings are a) the command line utilities required to configure and administer the principal aspects of the security extensions, such as the communication rules and process compartment labels; b) the loadable modules that implement this functionality within the kernel; and c) the kernel modifications made to take advantage of this functionality. These three major components will now be described in more detail, as follows.

a) Command-Line Utilities

‘CACC’ is a command line utility to add, delete and list rules via /dev/cacc and /proc/cacc interfaces provided by a cac kernel-loadable module (not shown). Rules can either be entered on the command line, or can be read from a text-file.

In this exemplary embodiment of the invention, rules take the following format:

<rule>::=<source>[<port>]-><destination>[<port>]<method list><netdev>

where:

<identifier> == (<compartment>¦<host>¦<net>) [<port>]

<compartment> == ‘COMPARTMENT’ <comp_name>

<host> == ‘HOST’ <host_name>

<net> == ‘NET’ <ip_addr><netmask>

<net> == ‘NET’ <ip_addr> ‘/’ <bits>

<Comp_name> == A valid name of a compartment

<host_name> == A known hostname or IP address

<ip_addr>== An IP address in the form a.b.c.d

<netmask> == A valid netmask, in the form a.b.c.d

<bits> == The number of leftmost bits in the netmask . . . 0 thru 31

<method_list> == A list of comma-separated methods (In this exemplary embodiment, methods supported are: TCP (Transmission Control Protocol), UDP (User Datagram Protocol), and ALL.

To add a rule, the user can enter ‘cacc -a <filename>’ (to read a rule from a text file, where <filename>is a file containing rules in the format described above), or ‘cacc -a rule’ (to enter a rule on the command line).

To delete a rule, the user can enter ‘cacc-d<filename>’, or cacc-d rule, or cacc-d ref(in this form, a rule can be deleted solely by its reference number which is output by listing the rules using the command cacc-1, which outputs or lists the rules in a standard format with the rule reference being output as a comment at the end of each rule.

By default, ‘cacc’ expects to find the compartment mapping file ‘cmap.txt’ and the method mapping file ‘mmap.txt’ in the current working directory. This can be overridden, however, by setting the UNIX environment variables CACC_CMAP and CACC_MMAP to where the files actually reside, in this exemplary embodiment of the invention.

Any syntax or semantic errors detected by cacc will cause an error report and the command will immediately finish, and no rules will be added or deleted. If a text file is being used to enter the rules, the line number of the line in error will be found in the error message.

Another command-line utility provided by this exemplary embodiment of the present invention is known as ‘lcu’, which provides an interface to an LNS kernel-module (not shown). Its most important function is to provide various administration-scripts with the ability to spawn processes in a given compartment and to set the compartment number of interfaces. Examples of its usage are:

1. ‘lcu setdev eth0 0xFFFF0000’

Sets the compartment number of the eth0 network interface to 0xFFFF0000

2. ‘lcu setprc 0x2-cap_mknod bash’

Switches to compartment 0x2, removes the cap_mknod capability and invokes bash

b) Kernel Modules

This exemplary embodiment of the present invention employs two kernel modules to implement custom ioctl( )s that enable the insertion/deletion of rules and other functions such as labeling of network interfaces. However, it is envisaged that the two modules could be merged and/or replaced with custom system-calls. In this embodiment of the present invention, the two kernel modules are named Ins and cac.

The Ins module implements various interfaces via custom ioctl( )s to enable:

1. A calling process to switch compartments.

2. Individual network interfaces to be assigned a compartment number.

Utility functions, such as process listing with compartment numbers and the logging of activity to kernel-level security checks.

The main client of this module is the lcu command-line utility described above.

The cac module implements an interface to add/delete rules in the kernel via a custom ioctl( ). It performs the translation between higher-level simplified rules into primitive forms more readily understood by kernel lookup routines. This module is called by the cacc and cgicacc user-level utilities to manipulate rules within the kernel.

c) Kernel Modifications

In this exemplary embodiment of the present invention, modifications have been made to the standard Linux kernel sources so as to introduce a tag on various data types and for the addition of access-control checks made around such tagged data types. Each tagged data type contains an additional struct csecinfo data-member which is used to hold a compartment number (as shown in FIG. 3 of the drawings). It is envisaged that the tagged data types could be extended to hold other security attributes. In general, the addition of this data-member is usually performed at the very end of a data-structure to avoid issues arising relating to the common practice casting pointers between two or more differently named structures which begin with common entries.

The net effect of tagging individual kernel resources is to very simply implement a compartmented system where processes and the data they generate/consume are isolated from one another. Such isolation is not intended to be strict in the sense that many covert channels exist (see discussion about processes below). The isolation is simply intended to protect obvious forms of conflict and/or interaction between logically different groups of processes.

In this exemplary embodiment of the present invention, there exists a single function cnet_chk_attr( ) that implements a yes/no security check for the subsystems which are protected in the kernel. Calls to this function are made at the appropriate points in the kernel sources to implement the compartmented behaviour required. This function is predicated on the subsystem concerned and may implement slightly different defaults or rule-conventions depending on the subsystem of the operation being queried at that time. For example, most subsystems implement a simple partitioning where only objects/resources having exactly the same compartment number result in a positive return value. However, in certain cases, the use of a no-privilege compartment 0 and/or a wildcard compartment −1L can be used, e.g. compartment 0 as a default ‘sandbox’ for unclassified resources/services; a wildcard compartment for supervisory purposes, like listing all processes on the subsystem prior to shutting down.

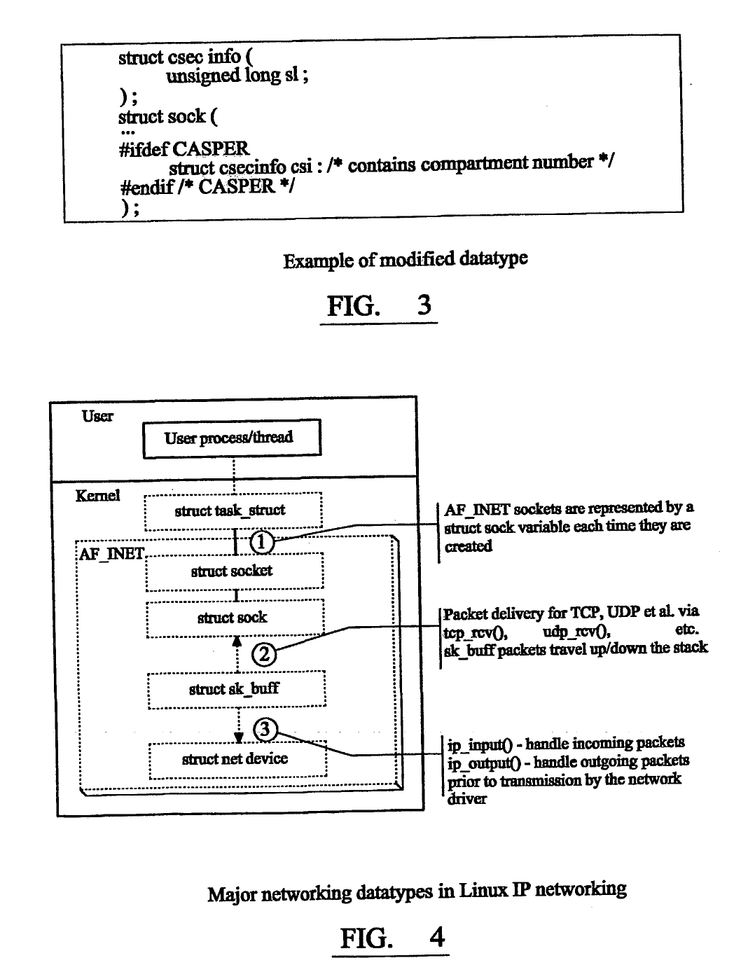

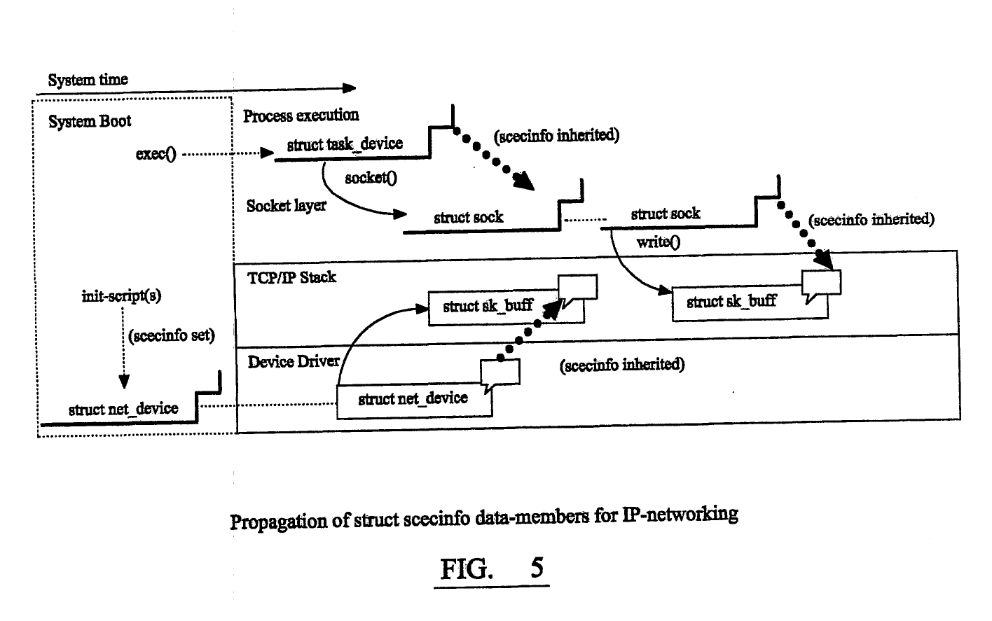

Referring to FIG. 4 of the drawings, standard Linux IP networking will first be explained. Each process or thread is represented by a task_struct variable in the kernel. A process may create sockets in the AF_INET domain for network communication over TCP/UDP. These are represented by a pair of struct socket and struct sock variables, also in the kernel.

The struct sock data type contains, among other things, queues for incoming packets represented by struct sk_buffs. It may also hold queues for pre-allocated sk_buffs for packet transmission. Each sk_buff represents an IP packet and/or fragment traveling up/down the IP stack. They either originate at a struct sock (or, more specifically, from its internally pre-allocated send-queue) and travel downwards for transmission, or they originate from a network driver and travel upwards from the bottom of the stack starting from a struct net_device which represents a network interface. When traveling downwards, they effectively terminate at a struct net_device. When traveling upwards, they are usually delivered to a waiting struct sock (actually, its pending queue).

Struct sock variables are created essentially indirectly by the socket( )-call (in fact, there are private per-protocol sockets owned by various parts of the stack within the kernel itself that cannot be traced to a running process), and can usually be traced to an owning user-process, i.e. a task_struct. There exists a struct net_device variable for each configured interface on the system, including the loopback interface. Localhost and loopback communications appear not to travel via a fastpath across the stack for speed, instead they travel up and down the stack as would be expected for remote host communications. At various points in the stack, calls are made to registered netfilter-modules for the purposes of packet interception.

By adding an additional csecinfo data-member to the most commonly used data types in Linux IP networking, it becomes possible to trace ownership and hence read/write dataflows of individual IP packets for all running processes on the system, including kernel-generated responses.

Thus, in order to facilitate this exemplary embodiment of the present invention, at least the major networking data types used in standard Linux IP networking have been modified. In fact, most of the data-structures modified to realize this embodiment of the invention are related to networking and occur in the networking stack and socket-support routines. The tagged network data structures serve to implement a partitioned IP stack. In this exemplary embodiment of the invention, the following data structures have been modified to include a struct csecinfo:

| | | |
|---|---|---|
| 1. | struct task_struct | processes (and threads) |
| 2. | struct socket | abstract socket representation |
| 3. | struct sock | domain-specific socket |
| 4. | struct sk_buff | IP packets or messages between sockets |
| 5. | struct net_device | network interfaces, e.g. eth(), lo, etc. |

During set-up, once the major data types were tagged, the entire IP-stack was checked for points at which these data types were used to introduce newly initialized variables into the kernel. Once such points had been identified, code was inserted to ensure that the inheritance of the csecinfo structure was carried out. The manner in which the csecinfo structure is propagated throughout the IP networking stack will now be described in more detail.

There are two named sources of struct csecinfo data members, namely per-process task_structs and per-interface net_devices. Each process inherits its csecinfo from its parent, unless explicitly modified by a privileged ioctl( ). In this exemplary embodiment of the present invention, the init-process is assigned a compartment number of 0. Thus, every process spawned by init during system startup will inherit this compartment number, unless explicitly set otherwise. During system startup, init-scripts are typically called to explicitly set the compartment numbers for each defined network interface. FIG. 5 of the drawings illustrates how csecinfo data-members are propagated for the most common cases.

All other data structures inherit their csecinfo structures from either a task_struct or a net_device. For example, if a process creates a socket, a struct socket and/or struct sock may be created which inherit the current csecinfo from the calling process. Subsequent packets generated by calling write( ) on a socket generate sk_buffs which inherit their csecinfo from the originating socket.

Incoming IP packets are stamped with the compartment number of the network interface on which it arrived, so sk_buffs traveling up the stack inherit their csecinfo structure from the originating net_device. Prior to being delivered to a socket, each sk_buff's csecinfo structure is checked against that of the prospective socket.

It will be appreciated that special care must be taken in the case of non-remote networking, i.e. in the case where a connection is made between compartments X and Y through any one of the number of network interfaces which is allowed by a rule of the form:

COMPARTMENT X->COMPARTMENT Y METHOD tcp

Because the security checks occur twice for IP networking, i.e. once on output and once on input, it is necessary to provide means for preventing the system from looking for the existence of these rules instead:

COMPARTMENT X->HOST a.b.c.d METHOD tcp (for output)

HOST a.b.c.d->COMPARTMENT Y METHOD tcp (for input)

which, although valid, may not be used in preference to the rule specifying source and destination compartments directly. To cater for this, in this exemplary embodiment of the invention, packets sent to the loopback device retain their original compartment numbers and are simply ‘reflected’ off it for eventual delivery. Note that, in this case, the security check occurs on delivery and not transmission. Upon receipt of an incoming local packet on the loopback interface, the system is set up to avoid overwriting the compartment number of the packet with that of the network interface and allow it to travel up the stack for the eventual check on delivery. Once there, the system performs a check for a rule of the form:

COMPARTMENT X->COMPARTMENT Y tcp

instead of

HOST a.b.c.d->COMPARTMENT Y METHOD tcp

because of the presence on the sk_buff of a compartment number that is not of a form normally allocated to network interfaces (network interfaces in this exemplary embodiment of the present invention, as a general rule, are allocated compartment numbers in the range 0xFFFF0000 and upwards and can therefore be distinguished from those allocated for running services).

Because the rules are unidirectional, the TCP layer has to dynamically insert a rule to handle the reverse data flow once a TCP connection has been set up, either as a result of a connect( ) or accept( ). This happens automatically in this exemplary embodiment of the invention and the rules are then deleted once the TCP connection is closed. Special handling occurs when a struct tcp_openreq is created to represent the state of a pending connection request, as opposed to one that has been fully set up in the form of a struct sock. A reference to the reverse-rule created is stored with the pending request and is also deleted if the connection request times out or fails for some other reason.

An example of this would be when a connection is made from compartment 2 to a remote host 10.1.1.1. The original rule allowing such an operation might have looked like this:

COMPARTMENT 2->NET 10.1.1.0/255.255.255.0 METHOD tcp

As a result, the reverse rule would be something like this (abc/xyz being the specific port-numbers used):

HOST 10.1.1.1 PORT abc->COMPARTMENT 2 PORT xyz METHOD tcp

In order to support per-compartment routing-tables, each routing table entry is tagged with a csecinfo structure. The various modified data structures in this exemplary embodiment of the invention are:

| | |
|---|---|
| 1. | struct rt_key |
| 2. | struct rtable |
| 3. | struct fib_rule |
| 4. | struct fib_node |

Inserting a route using the route-command causes a routing-table entry to be inserted with the csecinfo structure inherited from the calling context of the user-process, i.e. if a user invokes the route-command from a shell in compartment N, the route added is tagged with N as the compartment number. Attempts to view routing-table information (usually by inspecting /proc/net/route and /proc/net/rt_cache) are predicated on the value of the csecinfo structure of the calling user-process.

The major routines used to determine input and output routes which a sk_buff should take are ip_route_output( ) and ip_route_input( ). In this exemplary embodiment of the invention, these have been expanded to include an extra argument consisting of a pointer to the csecinfo structure on which to base any routing-table lookup. This extra argument is supplied from either the sk_buff of the packet being routed for input or output.

Kernel-inserted routing-entries have a special status and are inserted with a wildcard compartment number (−1L). In the context of per-compartment routing, they allow these entries to be shared across all compartments. The main purpose of such a feature is to allow incoming packets to be routed properly up the stack. Any security-checks occur at a higher level just prior to the sk_buff being delivered on a socket (or its sk_buff queue).

The net effect is that each compartment appears to have their individual routing tables which are empty by default. Every compartment shares the use of system-wide network-interfaces. In this exemplary embodiment of the invention, it is possible to restrict individual compartments to a strict subset of the available network-interfaces. This is because each network-interface is notionally in a compartment of its own (with its own routing table). In fact, to respond to an ICMP-echo request, each individual interface can optionally be configured with tagged routing-table entries to allow the per-protocol ICMP-socket to route its output packet.

Other Subsystems

UNIX Domain Sockets—Each UNIX domain socket is also tagged with the csecinfo structure. As they also use sk_buffs to represent messages/data traveling between connected sockets, many of the mechanisms used by the AF_NET domain described above apply similarly. In addition, security-checks are also performed at every attempt to connect to a peer.

System V IPC—Each IPC-mechanism listed above is implemented using a dedicated kernel structure that is similarly tagged with a csecinfo structure. Attempts to list, add or remove messages to these constructs are subject to the same security checks as individual sk_buffs. The security checks are dependent on the exact type of mechanism used.

Processes/Threads—Since individual processes, i.e. task_structs are tagged with the csecinfo structure, most process-related operations will be predicated on the value of the process's compartment number. In particular, process listing (via the /proc interface) is controlled as such to achieve the effect of a per-compartment process-listing. Signal-delivery is somewhat more complicated as there are issues to be considered in connection with delivery of signals to parent processes which may have switched compartments—thus constituting a 1-bit covert channel.

System Defaults

Per-protocol Sockets—The Linux IP stack uses special, private per-protocol sockets to implement various default networking behaviors such as ICMP-replies. These per-protocol sockets are not bound to any user-level socket and are typically initialized with a wildcard compartment number to enable the networking functions to behave normally.

Use of Compartment 0 as Unprivileged Default—The convention is to never insert any rules which allow Compartment 0 any access to other compartments and network-resources. In this way, the default behaviour of initialized objects, or objects which have not been properly accounted for, will fall under a sensible and restricted default.

Default Kernel Threads—Various kernel threads may appear by default, e.g. kswapd, kflushd, and kupdate to name but a few. These threads are also assigned a csecinfo structure per-task_struct and their compartment numbers default to 0 to reflect their relatively unprivileged status.

Sealing Compartments against Assumption of-Root-identity—Individual compartments may optionally be registered as ‘sealed’ to protect against processes in that compartment from successfully calling setuid(0) and friends, and also from executing any SUID-root binaries. This is typically used for externally-accessible services which may in general be vulnerable to buffer-overflow attacks leading to the execution of malicious code. If such services are constrained to being initially run as a pseudo-user (non-root) and if the compartment it executes in is sealed, then any attempt to assume the root-identity either by buffer-overflow attacks and/or execution of foreign instructions will fail. Note that any existing processes running as root will continue to do so.

The kernel modifications described previously serve to support the hosting of individual user-level services in a protected compartment. In addition to this, the layout, location and conventions used in adding or removing services in this exemplary embodiment of the invention will now be described.

Individual services are generally allocated a compartment each. However, what an end-user perceives as a service may actually end up using several compartments. An example would be the use of a compartment to host an externally-accessible Web-server with a narrow interface to another compartment hosting a trusted gateway agent for the execution of CGI-binaries in their own individual compartments. In this case, at least three compartments would be needed:

| | |
|---|---|
| | * one for the web-server processes; |
| | * one for the trusted gateway agent which executes CGI-binaries; |
| and | |
| | * as many compartments as are needed to properly categorize each |
| | CGI binary, as the trusted gateway will fork/exec CGI-binaries |
| | in their configured compartments. |

Every compartment has a name and resides as a chroot-able environment under /compt.

Examples used in an exemplary embodiment of the present invention include:

| Location | Description |
|---|---|
| /compt/admin | Admin HTTP-server |
| /compt/omailout | Externally visible HTTP-server hosting |
| | OpenMail server processes |
| /compt/omailin | Internal compartment hosting OpenMail |
| | server processes |
| /compt/web1 | Externally visible HTTP-server |
| /compt/web1mcga | Internal Trusted gateway agent for Web1's |
| | CGI-binaries |

In addition, the following subdirectories also exist:

1. /compt/etc/cac/bin—various scripts and command-line utilities for managing compartments

2. /compt/etc/cac/rules—files containing rules for every registered compartment on the system

3. /compt/etc/cac/encoding—configuration file for the cacc-utility, e.g. compartment-name mappings

To support the generic starting/stopping of a compartment, each compartment has to conform to a few basic requirements:

1. be chroot-able under its compartment location/compt/<name>

2. provide /compt/<name>/startup and /compt/<name>/shutdown to start/stop the compartment

3. startup and shutdown scripts are responsible for inserting rules, creating routing-tables, mounting filesystems (e.g. /proc)and other per-service initialization steps

In general, if the compartment is to be externally visible, the processes in that compartment should not run as root by default and the compartment should be sealed after initialization. Sometimes this is not possible due to the nature of a legacy application being integrated/ported, in which case it is desirable to remove as many capabilities as possible in order to prevent the processes from escaping the chroot-jail, e.g. cap_mknod.

Due to the fact that the various administration scripts require access to each configured compartment's filesystem, and that these administration-scripts are called via the CGI-interface of the administration Web-server, it is the case that these scripts cannot reside as a normal compartment, i.e. under /compt/<name>.

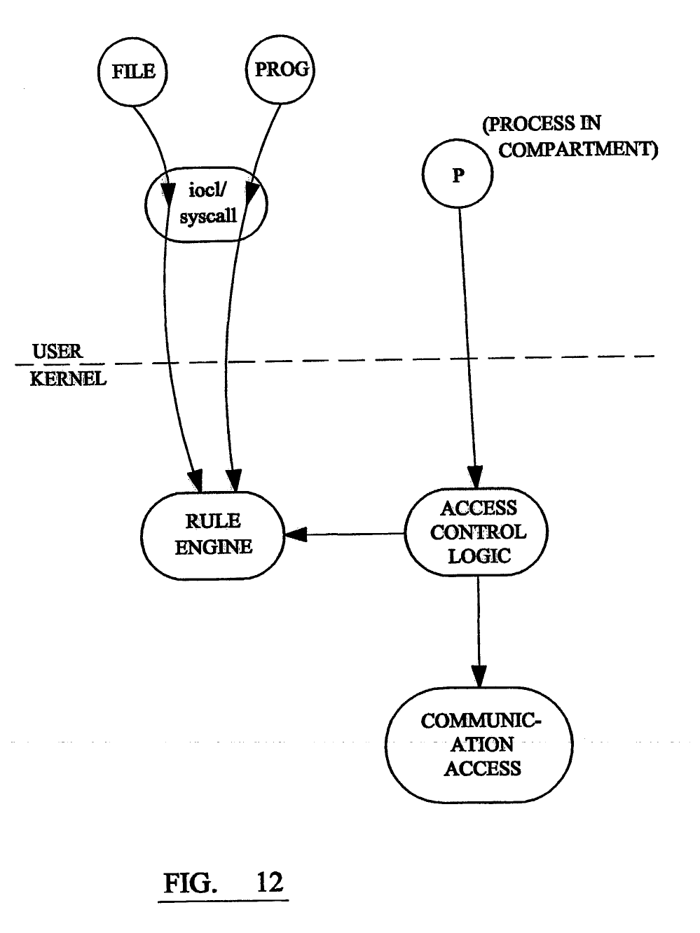

In this exemplary embodiment of the invention, the approach taken is to enclose the chroot-able environment of the administration scripts around every configured compartment, but to ensure that the environment is a strict subset of the host's filesystem. The natural choice is to make the chroot-jail for the administration scripts to have its root at/compt. The resulting structure is illustrated schematically in FIG. 11 of the drawings.

Since compartments exist as chroot-ed environments under the /comp directory, application-integration requires the usual techniques used for ensuring that they work in a chroot-ed environment. A common technique is to prepare a cpio-archive of a minimally running compartment, containing a minimal RPM-database of installed software. It is usual to install the desired application on top of this and, in the case of applications in the form of RPM's, the following steps could be performed:

| | |
|---|---|
| root@tlinux# | chroot/compt/app1 |
| root@tlinux# | rpm-install <RPM-package-filename> |
| root@tlinux# | [Change configuration files as required, e.g. httpd.conf] |
| root@tlinux# | [Create startup/shutdown scripts in /compt/appl] |

The latter few steps may be integrated into the RPM-install phase. Reductions in disk-space can be achieved by inspection: selectively uninstalling unused packages via the rpm-command. Additional entries in the compartment's /dev-directory may be created if required, but /dev is normally left substantially bare in most cases. Further automation may be achieved by providing a Web-based interface to the above-described process to supply all of the necessary parameters for each type of application to be installed. No changes to the compiled binaries are needed in general, unless it is required to install compartment-aware variants of such applications.

A specific embodiment of one aspect of the present invention has been described in detail above. However, a variety of different techniques may be used in the implementation of the general concept of containment provided by the present invention. It is obviously undesirable to rewrite the operating system because it is necessary to be able to reuse as many user-level applications as possible. This leaves various interposition techniques, some of which are listed below, and can be categorized as either primarily operating at the user-level or kernel-based.

User-Level Techniques

The following outlines three common user-level techniques or mechanisms.

1. The Strace( ) Mechanism

This mechanism uses the functionality built into the system kernel to trace each system-call of a chosen process. Using this mechanism, each system-call and its arguments can be identified and the system-call is usually either allowed to proceed (sometimes with modified arguments) or to fail according to a defined security policy.

This mechanism, while suitable for many applications, has a number of drawbacks. One of these drawbacks becomes apparent in the case of the ‘runaway child’ problem, in which a process P which is being traced may fork a child Q which is scheduled to run before P returns from the fork( ) system-call. Since strace( ) works by attaching to processes using process ID's (PID's), and the PID of Q is not necessarily returned to P (and hence the tracer) before Q is actually scheduled to run, there is a risk that Q would be allowed to execute some arbitrary length of code before the tracer can be attached to it.

One solution to this problem is to check every system-call in the kernel for as-yet untraced processes and to trap them there, for example, by forcefully ‘putting them to sleep’ so that the tracer can eventually catch up with them. This solution would, however, require an additional kernel component.

2. System-Call Wrapping

Another drawback of this mechanism occurs in the case that there exists a race-condition where arguments to a traced system-call can be modified. The window where this occurs happens between the tracer inspecting the set of arguments and actually allowing the system call to proceed. A thread sharing the same address-space as the traced process can modify the arguments in-memory during this interval.

Using this mechanism, system-calls can be wrapped using a dynamically linked shared library that contains wrappers to system-calls that are linked against a process which is required to be trace. These wrappers could contain call-outs to a module that makes a decision according to a predefined security policy.

One drawback associated with this mechanism is that it may be easily subverted if the system-calls that a process presumes to use are not unresolved external references and cannot be linked by the dynamic loader. It is also possible to make a system-call that by-passes the wrapper if the process performs the soft-interrupt itself with the correct registers set up like a normal system-call. In this case, the kernel handles the call without passing through a wrapper. In addition, in some cases, the dependence on the LD_PRELOAD environment variable might also be an unacceptable weak link.

3. User-Level Authorization Servers

This category includes authorization servers in user-space acting on data supplied via a private channel to the kernel. Although very effective in many cases, this approach does have a number of disadvantages, namely I) each system-call being checked incurs at least two context-switches, making this solution relatively slow; ii) interrupt routines are more difficult to bridge into user-space kernels due to the requirement that they do not sleep; and iii) a kernel-level component is usually required to enforce mandatory tracing.

Despite the disadvantages of the user-level approaches outlined above, user-level techniques to implement a trusted operating system in accordance with one aspect of the present invention have the advantage of being relatively easy to develop and maintain, although in some circumstances they may be insufficient in the implementation of system-wide mandatory controls.

Ultimately, the aim of the present invention is to contain running applications, preferably implemented by a series of mandatory access controls which cannot be overridden on a discretionary basis by an agent that has not been authorized directly by the security administrator. Implementing containment in a fashion that is transparent to running third-party applications can be achieved by kernel-level access controls. By examining the possible entry points and separating out the interactions of the kernel subsystems within and against each other, it becomes possible to segment the view of the kernel and its resources with respect to the running applications.

Such a scheme of segmentation is mandatory in nature due to its implementation within the kernel itself—there is no discretionary aspect that can be overridden by a running application unless it is made explicitly aware of the containment scheme and has been re-written to take advantage of it.

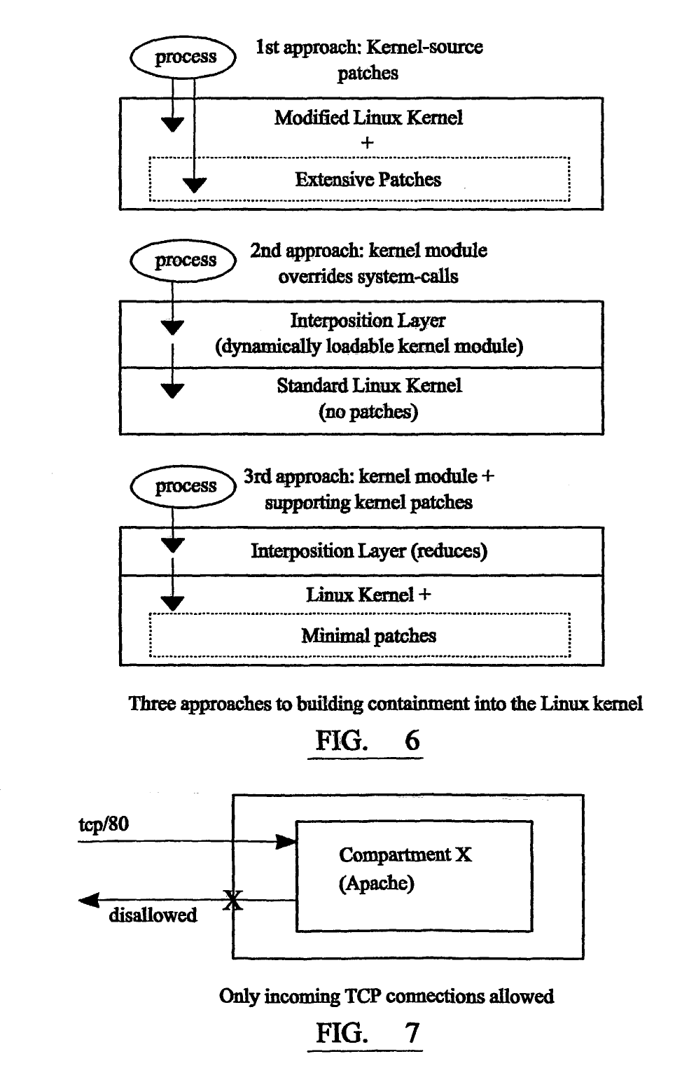

Three examples of kernel-level approaches to implementing the present invention are outlined below and illustrated in FIG. 6 of the drawings. The first approach is based primarily on patches to the kernel and its internal data structures. The second approach is entirely different in that it does not require any kernel patches at all, instead being a dynamically loadable kernel module that operates by replacing selected system calls and possibly modifying the run-time kernel image. Both of these approaches require user-level configuration utilities typically operating via a private channel into the kernel. The third approach represents a compromise between the absolute controls offered by the first approach versus the independence from kernel-source modifications offered by the second.

1. Source-Level Kernel Modifications to Support Containment (V1)

This approach is implemented as a series of patches to standard operating system (in this case, Linux) kernel sources. There is also a dynamically loadable kernel module that hosts the logic required to maintain tables of rules an also acts as an interface between the kernel and user-space configuration utilities. The kernel module is inserted early in the boot-sequence and immediately enforces a restrictive security model in the absence of any defined rules. Prior to this, the kernel enforces a limited security model designed to allow proper booting with all processes being spawned in the default compartment 0 that is functional but essentially useless for most purposes. Once the kernel module is loaded, the kernel switches from its built-in model to the one in the module. Containment is achieved by tagging kernel resources and partitioning access to these depending on the value of the tags and any rules which may have been defined.

Thus, each kernel resource required to be protected is extended with a tag indicating the compartment that the resource belongs to (as described above). A compartment is represented by a single word-sized value within the kernel, although more descriptive string names are used by user-level configuration utilities. Examples of such resources include data-structures describing:

individual processes

shared-memory segments

semaphores, message queues

sockets, network packets, network-interfaces and routing-table enquiries

A complete list of modified data structures to support this approach to containment according to an exemplary embodiment of the invention is given in Appendix 7.1 attached hereto. As explained above, the assignment of the tag occurs largely through inheritance, with the init-process initially being assigned to compartment 0. Any kernel objects created by a process inherit the current label of the running process. At appropriate points in the kernel, access-control checks are performed through the use of hooks to a dynamically loadable security-module that consults a table of rules indicating which compartments are allowed to access the resources of another compartment. This occurs transparently to the running applications.

Each security check consults a table of rules. As described above, each rule has the form:

source->destination method m [attr]

[netdev n]

where:

source/destination is one of:

COMPARTMENT (a named compartment)

HOST (a fixed IPv4 address)

NETWORK (an IPv4 subnet)

| | |
|---|---|
| m: | supported kernel mechanism, e.g. tcp, udp, msg (message queues), |
| | shm (shared-memory), etc. |
| attr: | attributes further qualifying the method m |
| n: | a named network-interface if applicable, e.g. eth() |

An example of such a rule which allows processes in the compartment named “WEB” to access shared-memory segments, for example using shmat/shmdt( ), from the compartment named “CGI” would look like:

COMPARTMENT:WEB->COMPARTMENT:CGI METHOD shm

Present also are certain implicit rules, which allow some communications to take place within a compartment, for example, a process might be allowed to see the process identifiers of processes residing in the same compartment. This allows a bare-minimum of functionality within an otherwise unconfigured compartment. An exception is compartment 0, which is relatively unprivileged and where there are more restrictions applied. Compartment 0 is typically used to host kernel-level threads (such as the swapper).

In the absence of a rule explicitly allowing a cross-compartment access to take place, all such attempts fail. The net effect of the rules is to enforce mandatory segmentation across individual compartments, except for those which have been explicitly allowed to access another compartment's resources.

The rules are directional in nature, with the effect that they match the connect/accept behaviour of TCP socket connections. Consider a rule used to specify allowable incoming HTTP connections of the form:

HOST*->COMPARTMENT X METHOD TCP PORT 80

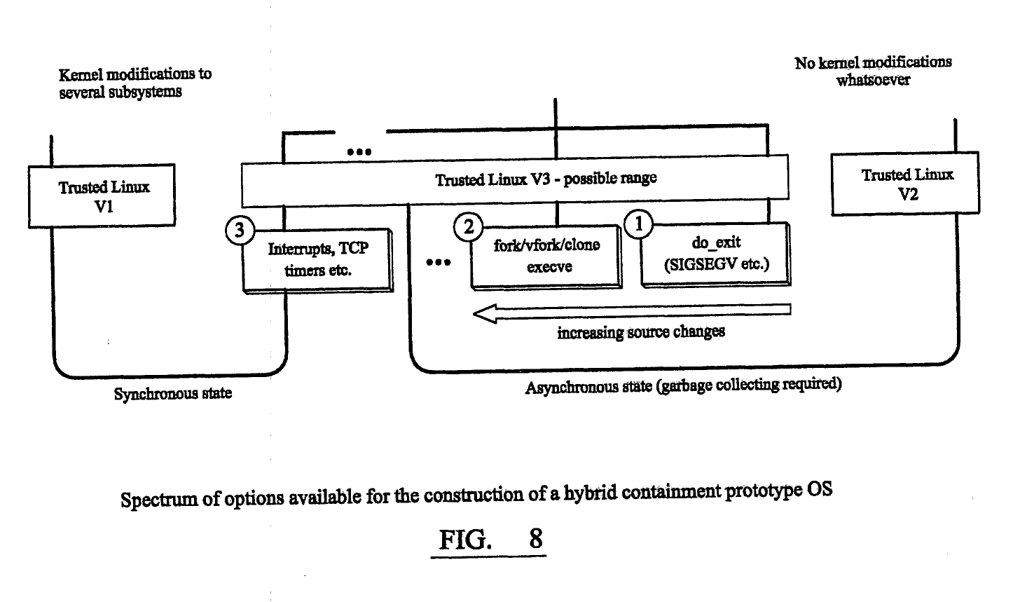

This rule specifies that only incoming TCP connections on port 80 are to be allowed, but not outgoing connections (see FIG. 7). The directionality of the rules permits the reverse flow of packets to occur in order to correctly establish the incoming connection without allowing outgoing connections to take place.

The approach described above has a number of advantages. For example, it provides complete control over each supported subsystem and the ability to compile out unsupported ones, for example, hardware-driven card-to-card transfers. Further, this approach provides relatively comprehensive namespace partitioning, without the need to change user-space commands such as ps, netstat, route, ipcs etc. Depending on the compartment that a process is currently in, the list of visible identifiers changes according to what the rules specify. Examples of namespaces include Process-table via/proc, SysV IPC resource-identifiers, Active, closed and listening sockets (all domains), and Routing table entries.

Another advantage of this approach is the synchronous state with respect to the kernel and its running processes. In view of the fact that the scalar tag is attached to the various kernel-resources, no complete lifetime tracking needs to be done which is a big advantage when considering the issue of keeping the patches up to date as it requires a less in-depth understanding of where kernel variables are created/consumed. Further, fewer source changes need to be made as the inheritance of security tags happens automatically through the usual C assignment-operator (=) or through memcpy( ), instead of having to be explicitly specified through the use of #ifdefs and clone-routines.

In addition, there is no need to recursively enumerate kernel resources at the point of activation as such accounting is performed the moment the kernel starts. Further, this approach provides a relatively speedy performance (about 1-2% of optimal) due to the relatively small number of source changes to be made. Depending on the intended use of the system, the internal hash-tables can be configured in such a way that the inserted rules are on average 1-level deep within each hash-bucket—this makes the rule-lookup routines behave in the order of O(1).

However, despite the numerous advantages, this approach does require source modifications to the kernel, and the patches need to be updated as new kernel revisions become available. Further, proprietary device-drivers distributed as modules cannot be used due to possible structure-size differences.

2. System-Call Replacement via Dynamically Loadable Kernel Modules (V2)

This approach involves implementing containment in the form of a dynamically loadable kernel module and represents an approach intended to recreate the functionality of the Source-level Kernel Modification approach outlined above, without needing to modify kernel sources.

In this approach, the module replaces selected system-calls by overwriting the sys_call_table[ ] array and also registers itself as a netfilter module in order to intercept incoming/outgoing network packets. The module maintains process ID (PID) driven internal state-tables which reflect the resources claimed by each running process on the system, and which are updated at appropriate points in each intercepted system call. These tables may also contain security attributes on either a per-process or per-resource basis depending on the desired implementation.

The rule format and syntax for this approach is substantially as described with regard to the Source-level Kernel Modification approach outlined above, and behaves in a similar manner. Segmentation occurs through the partitioning of the namespaces at the system-call layer. Access to kernel resources via the original system-calls becomes conditional upon security checks performed prior to making the actual system call.

All system-call replacements have a characteristic pre/actual/post form to reflect the conditional nature of how system-calls are handled in this approach.

Thus, this approach has the advantage that no kernel modifications are required, although knowledge of the kernel internals is needed. Further, the categorization of bugs becomes easier with the ability to run the system while the security module is temporarily disabled.

There are also a number of disadvantages and/or issues to be considered in connection with this approach. Firstly, maintaining true synchronous state with respect to the running processes is difficult for various reasons that are mostly due to the lack of a comprehensive kernel event notification mechanism. For example, there is no formal mechanism for catching the situation where processes exit abnormally, e.g. due to SIGSEGV, SIGBUS, etc. One proposed solution to this problem involves a small source code modification to do_exit( ) to provide a callback to catch such cases. In one exemplary embodiment, a kernel-level reaper thread may be used to monitor the global tasklist and perform garbage collecting on dead PID's. This introduces a small window of insecurity which is somewhat offset by the fact that PID's cycle upwards and the possibility of being reassigned a previously used PID within a single cycle of the reaper thread is relatively small.

With regard to the runaway-child problem described above, fork/vfork/clone does not return with the child's PID until possibly after the child is scheduled to run. If the module implementation creates PID-driven state-tables, this means that the child may invoke system-calls prior to a state-entry being created for it. The same problem exists in the strace command (as described above) which cannot properly follow forked children due to the need to attach to child processes. One possible solution to this problem is to intercept all system-calls with pre-conditional checks, but this solution is relatively slow and ineffective in some circumstances.

Another possible solution is relatively complex, and illustrated in Appendix 7.2 attached hereto.

1. fork( )—the return address on the stack of the parent is modified prior to calling the real fork( )-system call by poking the stack in the user-space. This translates to the child inheriting the modified return address. The modified return address is set to point to 5 bytes prior to its original value which causes the fork( ) system call to be called again by the child as its first action. The system then intercepts this and creates the necessary state entries. The parent has the saved return-address restored just prior to returning from fork( ) and so proceeds as normal. (Note that 5 bytes is exactly the length of the instruction for a form of the IA-32 far call. Other variants may be wrapped using LD_PRELOAD and a syscall wrapper that has the desired 5-byte form).

2. clone( )—the method used for a forked child (as described above) is not suitable for handling a cloned child due to the different way the stack is set up. The proposed solution instead is to:

a. Call brk( ) on behalf of the user-process to allocate a small 256-byte chunk of memory;

b. Copy a prepared chunk of executable code into this newly-allocated memory. This code will call a designated system-call before proceeding as normal for a cloned child;

c. Modify the stack of the user-process so that it executes this newly-prepared chunk of code instead of the original routine supplied in the call to clone( );

d. Save the original pointer to the routine supplied by the user-process to clone.

When the cloned child first executes, it will run the prepared chunk of code that makes a system-call which returns the pointer to the original routine that it was supposed to have executed. The child is trapped at this point and state-entries are created for it. The cloned child then executes the original routine as normal. (See Appendix 7.4 attached hereto).

In both cases, the child is forcibly made to call down to the kernel-module where it can be trapped.

Another possible solution is to change the ret_from_fork( ) routine in the kernel to provide a callback each time a child is created. Alternatively, the do_fork( ) kernel function which implements fork/vfork/clone could be modified.

Tracking close-on-exec behaviour is also difficult in this implementation without intimate knowledge of the filesystem-related structures within each process structure.

Another issue to be considered in connection with this approach is that the module should typically be loaded very early in the boot sequence to start monitoring kernel resources as soon as possible because post-enumerating such resources becomes progressively more difficult as the boot sequence advances. It should also be noted that the process of checking for the validity of system-call arguments in this approach is shifted to the kernel module instead of the original system-calls. As such, because the original kernel is not modified, additional overhead is introduced with this approach. Similarly, maintaining what is essentially replicated state information apart from the kernel adds overhead in terms of memory usage and processor cycles.

Yet another disadvantage is the loss of per-compartment routing and the features that depend on it, namely virtualized ARP caches and the ability to segment back-end network access using routes. This is because the routing code is run unmodified without tagged data structures. Finally, it is considered very difficult, if not impossible, to provide a single binary module that caters to all configurations. The size and layout of data-members within a structure depend on the config-options in that particular kernel-build. For example, specifying that netfilter be compiled causes some networking-related data structures to change in size and layout.

There are a number of issues to be considered in connection with the deployment of the dynamically loadable kernel module. Because the size of certain kernel data structures depends on the actual configuration options determined at build-time, i.e. the number of data members can vary depending on what functionality has been selected to be compiled in the kernel, the need to match the module to the kernel is essential. Thus, modules can either be built against known kernels, in which case, the sources and the configuration options (represented by a config-file) is readily available, or modules can be built at the point of installation, in which case the sources to the module would have to be shipped to the point of installation.

3. Hybrid System-Call Replacement with Support from Kernel-Based Changes

Referring to FIG. 8 of the drawings, there is illustrated schematically some of the options available for the construction of a hybrid containment operating system which combines some of the features of the modified kernel-based approach (V1) and the system-call replacement approach (V2) as described above.

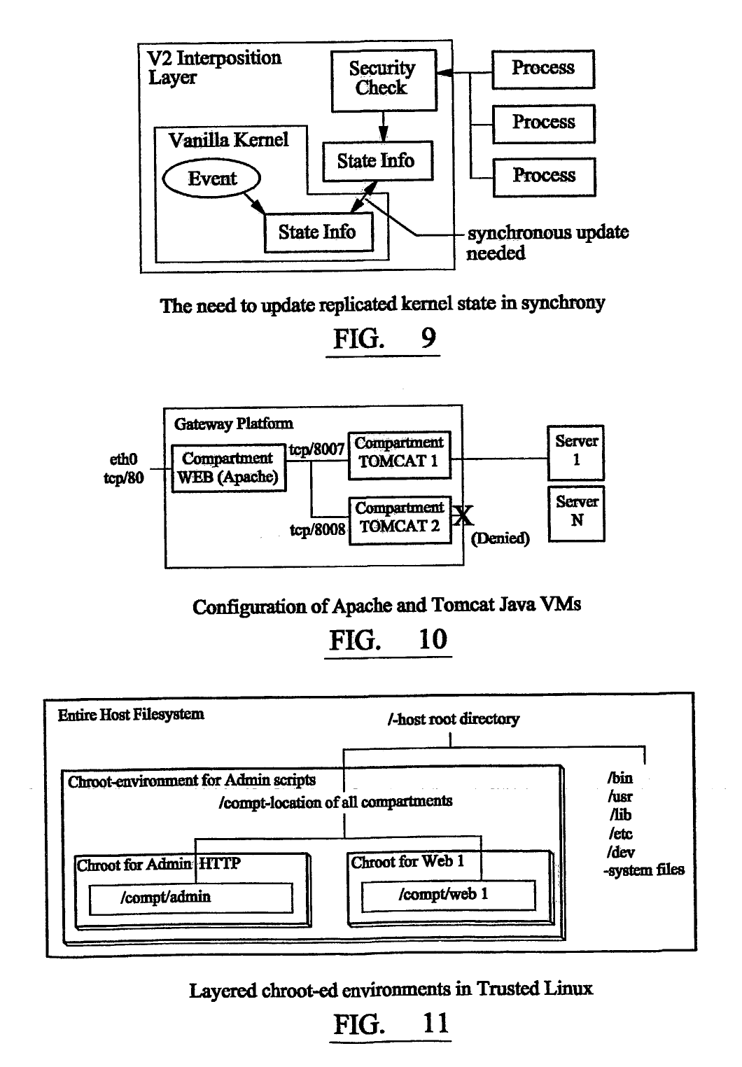

In terms of maintaining state relative to the running kernel, the V1 approach is much more closely in step with the actual operation of the kernel compared to V2, which remains slightly out of step due to the lack of proper notification mechanisms and the need for garbage collecting. The state information in V1 is synchronous with respect to the kernel proper, and V2 is asynchronous. Synchrony is determined by whether or not the internal state-tables are updated in lock-step fashion with changes in the actual kernel state, typically within the same section of code bounded by the acquisition of synchronization primitives. The need for synchrony is illustrated in FIG. 9 of the drawings, where changes to kernel state arising from an embedded source need to be reflected in the replicated state at the interposition layer.

Referring back to FIG. 8 of the drawings, the determination of relative advantages in connection with the V1 and V2 approaches works on a sliding scale between the position of synchronous state typified by the V1 approach and the asynchronous one offered by the V2 approach, depending on how aggressively a developer wishes to modify kernel sources in order to achieve a near-synchronous state. FIG. 8 illustrates three points at which changes to the V2 approach might provide significant advantages at the relatively slight expense of kernel source code changes.

1. do_exit( )—a 5-line change in the do_exit( ) kernel function would enable a callback to be provided to catch changes to the global tasklist as a result of processes terminating abnormally. Such a change does not require knowledge of how the process termination is handled, but an understanding of where the control paths lie.

2. Fork/vfork/clone—another 5-line change in the do_fork kernel function would allow the proper notification of child PID's before they can be scheduled to run. An alternative is to modify ret_from_fork( ) but this is architecture-dependent. Neither of these options requires knowledge of process setup, just an awareness of the nature of PID creation and the locks surrounding the PID-related structures.

3. Interrupts, TCP timers, etc.—this category covers all operations carried out asynchronously in the kernel as a result of either a hard/soft IRQ, tasklets, internal timers or any execution context not traceable to a user-process. An example is the TCP timewait hash buckets used to maintain sockets that have been closed, but are yet to disappear completely. The hashtables are not publicly exported and changes to them cannot be tracked, as there are no formal API's for callbacks. If it is required to perform accounting on a per-packet basis (which is a major advantage in the V1 approach and from which several features are derived), then this category of changes to the kernel sources is required. However, in order to carry out those (relatively extensive) changes, an in-depth knowledge of the inner workings of the subsystems involved.

One of the most important applications of the present invention is the provision of a secure web server platform with support for the contained execution of arbitrary CGI-binaries and with any non-HTTP related processing (e.g. Java servlets) being partitioned into separate compartments, each with the bare minimum of rules required for their operation. This is a more specific configuration than the general scenario of:

1. Secure gateway systems which host a variety of services, such as DNS, Sendmail, etc. Containment or compartmentalization in such systems could be used to reduce the potential for conflict between services and to control the visibility of back-end hosts on a per-service basis.

2. Clustered front-ends (typically HTTP) to multi-tiered back-ends, including intermediate application servers. Compartmentalization in such systems has the desired effect of factoring out as much code as possible that is directly accessible by external clients.

In summary, the basic principle behind the present invention is to reduce the size and complexity of any externally accessible code to a minimum, which restricts the scope by which an actual security breach may occur. The narrowest of interfaces possible are specified between the various functional components which are grouped into individual compartments by using the most specific rule possible and/or by taking advantage of the directionality of the rules.

Returning now to FIG. 2 of the drawings, there is illustrated a web-server platform which is configured based on V1 as the chosen approach. As described above, each web-server is placed in its own compartment. The MCGA daemon handles CGI execution requests and is placed in its own compartment. There are additional compartments for administration purposes as well. Also shown is the administration CGI utilities making use of user-level command line utilities to configure the kernel by the addition/deletion of rules and the setting of process labels. These utilities operate via a privileged device-driver interface. In the kernel, each subsystem contains call-outs to a custom security module that operates on rules and configuration information set earlier. User-processes that make system calls will ultimately go through the security checks present in each subsystem and the corresponding data is manipulated and tagged appropriately.

The following description is intended to illustrate how the present invention could be used to compartmentalize a setup comprising an externally facing Apache Web-server configured to delegate the handling of Java servlets or the serving of JSP files to two separate instances Jakarta/Tomcat, each running in its own compartment. By default, each compartment uses a chroot-ed filesystem so as not to interfere with the other compartments.

FIG. 10 of the drawings illustrates schematically the Apache processes residing in one compartment (WEB). This compartment is externally accessible using the rule:

HOST*->COMPARTMENT WEB

METHOD TCP PORT 80 NETDEV eth0

The presence of the NETDEV component in the rule specifies the network-interfaces which Apache is allowed to use. This is useful for restricting Apache to using only the external interface on dual/multi-homed gateway systems. This is intended to prevent a compromised instance of Apache being used to launch attacks on back-end networks through internally facing network interfaces. The WEB compartment is allowed to communicate to two separate instances of Jakarta/Tomcat (TOMCAT1 and TOMCAT2) via two rules which take the form:

COMPARTMENT:WEB->COMPARTMENT:TOMCAT1

METHOD TCP PORT 8007

COMPARTMENT:WEB->COMPARTMENT TOMCAT2

METHOD TCP PORT 8008

The servlets in TOMCAT1 are allowed to access a back-end host called Server1 using this rule:

COMPARTMENT:TOMCAT1->HOST:SERVER1

METHOD TCP . . .

However, TOMCAT 2 is not allowed to access any back-end hosts at all—which is reflected by the absence of any additional rules. The kernel will deny any such attempt from TOMCAT2. This allows one to selectively alter the view of a back-end network depending on which services are being hosted, and to restrict the visibility of back-end hosts on a per-compartment basis.

It is worth noting that the above four rules are all that is needed for this exemplary configuration. In the absence of any other rules, the servlets executing in the Java VM cannot initiate outgoing connections; in particular, it cannot be used to launch attacks on the internal back-end network on interface eth1. In addition, it may not access resources from other compartments (e.g. shared-memory segments, UNIX-domain sockets, etc.), nor be reached directly by remote hosts. In this case, mandatory restrictions have been placed on the behaviour of Apache and Jakarta/Tomcat without recompiling or modifying their sources.

An example of application integration will now be described with reference to OpenMail 6.0. The OpenMail 6.0 distribution for Linux consists of a large 160Mb+ archive of some unspecified format, and an install-script ominstall. To install OpenMail, it is first necessary to chroot to an allocated bare-bones inner-compartment:

| | |
|---|---|
| root@tlinux# | chroot/compt/omailin |
| root@tlinux# | ominstall |
| root@tlinux# | [Wait for OpenMail to install naturally] |
| root@tlinux# | [Do additional configuration if required, e.g. set up |
| | mailnodes] |

Since OpenMail 6.0 has a Web-based interface which is also required to be installed, another bare-bones compartment is allocated (omailout) and an Apache HTTP-server is installed o handle the HTTP queries:

| | |
|---|---|
| root@tlinux# | chroot /compt/omailout |
| root@tlinux# | rpm --install <apache-RPM-filoename> |
| root@tlinux# | Configure Apache's httpd.conf to handle CGI-requests as |
| | required by OpenMail's installation instructions] |

At this point, it is also necessary to install the CGI-binaries which come with OpenMail 6.0 so that they can be accessed by the Apache HTTP-server. This can be done by one of two methods:

Install OpenMail again in omailout and remove unnecessary portions, e.g. server-processes; or

Copy the OpenMail CGI-binaries from omailin, taking care to preserve permissions and directory structure.

In either case, the CGI-binaries typically are placed in the cgi-bin directory of the Apache Web-server. If disk-space is not an issue, the former approach is more brute-force and works well. The latter method can be used if it is necessary to be sure of exactly which binaries are to be placed in the externally-facing omailout compartment. Finally, both compartments can be started:

root@tlinux# comp_start omailout omailin

It may be possible that 1P fragments are received with different originating compartment numbers. In such a case, the system may include means for disallowing fragment re-assembly to proceed with fragments of differing compartment numbers.

Support for various other network protocols may be included, e.g. IPX/SPX, etc.

It is envisaged that a more comprehensive method for filesystem protection than chroot-j ails might be used.

Referring to FIG. 13 of the drawings, the operation of an exemplary embodiment of the present invention is illustrated schematically. A gateway system 600 (connected to both an internal and external network) is shown. The gateway system 600 is hosting multiple types of services Service0, Service1 , . . . , ServiceN, each of which is connected to some specified back-end host, Host0, Host1 , . . . HostX, HostN, to perform its function, e.g. retrieve records from a back-end database. Many back-end hosts may be present on an internal network at any one time (not all of which are intended to be accessible by the same set of services). It is essential that, if these server-processes are compromised, they should not be able to be used to probe other back-end hosts not originally intended to be used by the services. The present invention is intended to limit the damage an attacker can do by restricting the visibility of hosts on the same network.

In FIG. 13, Service0 and Service1 are only allowed to access the network Subnet1 through the network-interface eth0. Therefore, attempts to access Host0/Host1 succeed because they are Subnet1, but attempts to access Subnet2 via eth1 fail. Further, ServiceN is allowed to access only HostX on eth1. Thus any attempt by ServiceN to access HostN fails, even if HostN is on the same subnet as HostX, and any attempt by ServiceN to access any host on Subnet1 fails.

The restrictions can be specified (by rules or routing-tables) by subnet or by specific host, which in turn may also be qualified by a specific subnet.

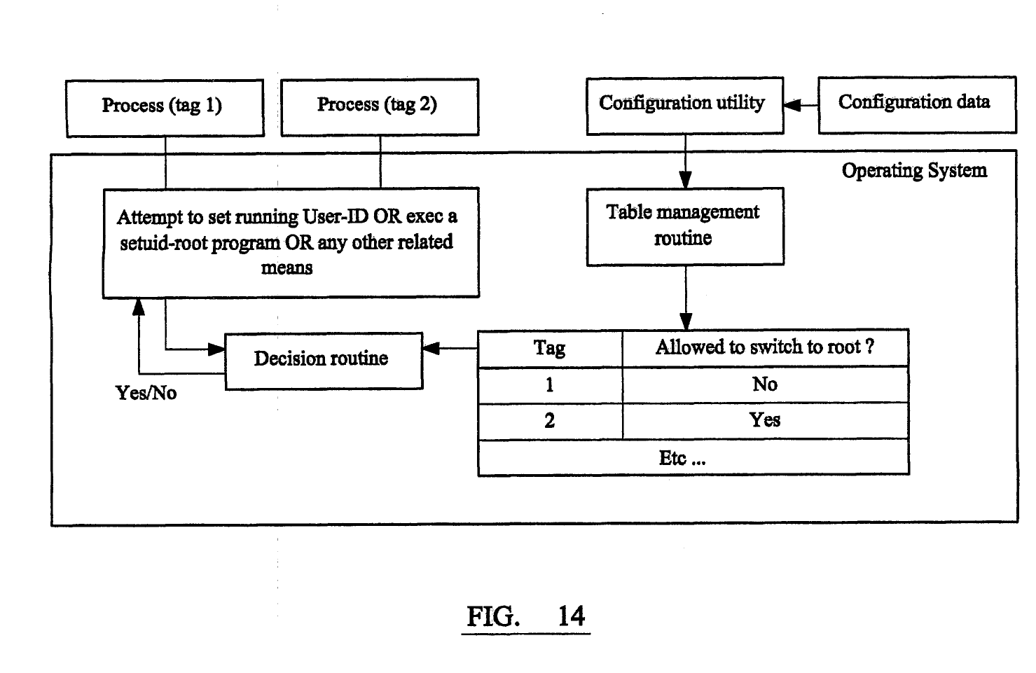

Referring to FIG. 14 of the drawings, the operation of an operating system according to an exemplary embodiment of the fourth aspect of the invention of our first co-pending International Application is illustrated schematically. The main preferred features of an exemplary embodiment of this aspect of the invention are:

1. Modifications to the source code of the operating system in the areas in which transitions to root are possible. Hooks are added to these points so that, at run-time, these call out to functions that either allow or deny the transition to take place.

2. Modifications to the source code of the operating system to mark each running process with a tag. As described above, processes which are spawned inherit their tag from their parent process. Special privileged programs can launch an external program with a tag different from its own (the means by which the system is populated with processes with different tags).

3. A mechanism by which a configuration-utility can specify to the operating system at run-time which processes associated with a particular tag are to be marked as “sealed”.

4. Configuration files describing data to be passed to the configuration-utility described above.

The present invention thus provides a trusted operating system, particularly Linux-based, in which the functionality is largely provided at the kernel level with a path-based specification of rules which are not accessed when files or programs are accessed. This is achieved by inferring any administrative privilege on running processes rather than on programs or files stored on disk. Such privileges are conferred by the inheritance of an administrative tag or label upon activation and thus there is no need to subsequently decode streams or packets for embedded security attributes, since streams or packets are not re-routed along different paths according to their security attributes.

Linux functionality is accessible without the need for trusted applications in user space and there is no requirement to upgrade or downgrade or otherwise modify security levels on running programs.

Embodiments of the present invention have been described above by way of examples only and it will be apparent to a person skilled in the art that modifications and variations can be made to the described embodiments without departing from the scope of the invention as defined by the appended claims.

1) An operating system comprising which dynamically assigns a label to a newly-installed adapter substantially upon activation thereof, the label depending upon the attributes of said adapter, and removes said label when said adapter is deactivated.

2) An operating system as claimed in claim 1, comprising a kernel which dynamically assigns and removes said label.

3) An operating system as claimed in claim 1, comprising software-routines which are invoked when a new adapter is activated.

4) An operating system as claimed in claim 3, in which the software-routines are modified to assign a label depending on the attributes of the newly-newly-installed adapter.

5) An operating system as claimed in claim 3, in which the labels are assigned by consulting a ruleset.

6) An operating system as claimed in claim 3, in which the labels are assigned by consulting a configuration table.

7) An operating system as claimed in claim 1, comprising software-routines which are invoked when an adapter is de-activated, to remove the label previously assigned.
